(19) United States
(12) Patent Application Publication
(10) Pub. No.: US 2024/0267460 A1
(43) Pub. Date: Aug. 8, 2024

(54) TRANSMISSION AND VISUALIZATION OF INTERACTIVE VOICE RESPONSE MENUS

(71) Applicant: International Business Machines Corporation, Armonk, NY (US)

(72) Inventors: Mauro Marzorati, Lutz, FL (US); Carolina Garcia Delgado, Zapopan (MX); Jeremy R. Fox, Georgetown, TX (US); Sarbajit K. Rakshit, Kolkata (IN)

(21) Appl. No.: 18/165,357

(22) Filed: Feb. 7, 2023

(51) Int. Cl. H04M 3/493; H04M 3/42

(52) U.S. Cl. CPC H04M 3/493; H04M 3/42382; H04M 2203/254

(57) ABSTRACT

Computer-implemented methods, systems and program products leveraging DTMF, SMS, and other transmission protocols to provide visualization of IVR menus, improving user-accessibility. Phones or other devices with DTMF decoding functions, internet connectivity and/or visualization capabilities place calls to an IVR system. DTMF codes are transmitted to IVR systems indicating compliance and request to receive IVR menus. IVR systems transmit DTMF codes encoding ASCII character sets for URLs whereupon devices can decode ASCII characters and fetch files visualizing IVR menus from the URL. Alternatively, IVR system may provide URLs using SMS text messages whereby devices provide a telephone number to the IVR system via DTMF. IVR system decodes the telephone number and transmits a representation of the URL using SMS protocol. The receiving device receiving the SMS message fetches the visualization of the IVR menu from the URL provided within the SMS message and use the menu to navigate the IVR system.

### BACKGROUND

The present disclosure relates generally to the mobile communications, communication interfaces and user-accessibility. More specifically the dynamic creation, transmission and/or visualization of interactive voice response (IVR) menus using one or more signaling protocols such as dual-tone multi-frequency signaling (DTMF).

IVR is an automated phone system that allows incoming callers to interact with a computer-operated telephone systems through the use of voice and DTMF tones inputted via a keypad. IVR allows callers to access information via the automated system that is able to provide pre-recorded messages to the caller without having to speak to an agent or representative. As part of the pre-recorded messages, menu options may be presented to the caller, allowing the caller to navigate the menu options by either entering corresponding numbers on their keypad or by verbally speaking the number or menu option using speech recognition technology to identify the caller's selections. As menu options are inputted by the caller, the call can be routed to specific information stored in databases, as well as departments, agents or specialists that can assist the caller with one or more specific requests.

DTMF (also referred to as Touch-Tone) is a telecommunication signaling system that is used to dial telephone numbers or issue commands to switching systems. DTMF signaling uses the voice-frequency band over telephone lines between telephone equipment, other communication devices and switching centers. DTMF was first developed in the Bell System in the United States and became known under the trademark Touch-Tone for use in push-button telephones supplied to telephone customers, starting in 1963. DTMF is standardized as ITU-T Recommendation Q.23. It is also known in the UK as MF4. DTMF encodes digits, letters and other symbols for telecommunication purposes using two simultaneous tones to represent each symbol. Each tone corresponds to a particular frequency, and the combination of two tones represents a specific symbol. For example, the digit “1” is represented by a combination of the frequencies 1209 Hz and 697 Hz, while the digit “2” is represented by a combination of the frequencies 1336 Hz and 697 Hz. The frequencies used in DTMF are carefully chosen to avoid harmonics that might cause false signals, and to ensure that the signals can be transmitted reliably over different types of telecommunication networks. When a user presses a key on a telephone keypad, the telephone generates the appropriate combination of tones, which are transmitted over the telephone network or computer networks to the receiving end, where they are decoded back into the original symbol.

### SUMMARY

Embodiments of the present disclosure relate to computer-implemented methods, associated computer systems and computer program products for visualizing menu options of an interactive voice response (IVR) system. The computer-implemented method comprises the steps of establishing a connection with the IVR system and transmitting a first message to the IVR system which includes a signal indicating to the IVR system that the device communicating with the IVR system is in compliance with devices for decoding signals of the IVR systems, as well as in compliance with displaying visualizations of menu options. The first message further requests a visualization of menu options from the IVR system. In response to the request, a second message is received, by the one or more processors. The second messaged is encoded with information describing a location of a file containing the visualization of the menu options for the IVR system. The second message is decoded, by the one or more processors, revealing the location of the file containing the visualization of the menu options for the IVR system, which is retrieved, by the one or more processors, and displayed on the device communicating with the IVR system.

An alternative embodiment of the present disclosure relates to a computer-implemented method and associated computer systems and programs for visualizing menu options of an IVR system. The computer-implemented method comprises the steps of establishing a connection with the IVR system and receiving from the IVR system, a first message encoded with information describing a length of a third message describing a location of a file containing a visualization of menu options for the IVR system. A second message is transmitted to the IVR system. The second message is encoded with information containing an address to send the third message. The third message is received from the IVR system at the address encoded within the second message, wherein the third message comprises a location of a file containing a visualization of menu options for the IVR system. Based on the location of the file provided within the third message, the file containing the visualization of the menu options of the IVR system is retrieved from the location and the visualization of the menu options for the IVR system is displayed.

### BRIEF DESCRIPTION OF THE DRAWINGS

The drawings included in the present disclosure are incorporated into, and form part of, the specification. The drawings illustrate embodiments of the present disclosure and, along with the description, explain the principles of the disclosure. The drawings are only illustrative of certain embodiments and do not limit the disclosure.

FIG. 1 depicts a block diagram illustrating an embodiment of a computer system and the components thereof, upon which embodiments described herein may be implemented in accordance with the present disclosure.

FIG. 2 depicts a block diagram illustrating an extension of the computing system environment of FIG. 1, wherein the computer systems are configured to operate in a network environment (including a cloud environment), and perform methods described herein in accordance with the present disclosure.

FIG. 3A depicts a functional block diagram describing an embodiment of a system for visualizing menu options of an IVR system, in accordance with the present disclosure.

FIG. 3B depicts a functional block diagram describing an alternative embodiment of a system for visualizing menu options of an IVR system, in accordance with the present disclosure.

FIG. 4A illustrates a sequence diagram depicting an embodiment of a method for visualizing menu options of an IVR system using DTMF.

FIG. 4B illustrates a sequence diagram depicting an alternative embodiment of a method for visualizing menu option of an IVR system using DTMF and SMS protocol.

FIG. 5A depicts an example embodiment of a visual mapping of an IVR menu (also referred to as an “IVR tree”) comprising a plurality of menu options of the IVR system, in accordance with the present disclosure.

FIG. 5B depicts the example embodiment of the visual mapping of the IVR menu shown in FIG. 5A, said visual mapping being displayed by a display device and includes an example of a predicted pathway being suggested to the user to input into the IVR system, in accordance with the present disclosure.

FIG. 5C depicts the example embodiment of the visual mapping of the IVR menu shown in FIG. 5A, wherein said visual mapping is being displayed by a display device and includes an example of dynamically tracking a user's menu selections inputted into the IVR system and displaying the pathway of selections as part of the visual mapping, in accordance with the present disclosure.

FIG. 6 illustrates a flow diagram describing an embodiment of a method for visualizing menu options of an IVR system using DTMF codes, in accordance with the present disclosure.

FIG. 7 illustrates a flow diagram describing an alternative embodiment of a method for visualizing menu option of an IVR system using a combination of DTMF codes and SMS protocols, in accordance with the present disclosure.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The corresponding structures, materials, acts, and equivalents of all means or steps plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments chosen and described are in order to best explain the principles of the disclosure, the practical applications and to enable others of ordinary skill in the art to understand the disclosure for various embodiments with various modifications as are suited to the particular use contemplated.

### Overview

During typical phone call-based services, such as a call received by an IVR system, the user placing the call listens to voice instructions presented as pre-recorded messages describing a plurality of options that a user may select. While listening to the voiced instructions, the user can select input from the available options using a keypad, onscreen keyboard or other device (either real or virtualized). Based on the user-selections from the menu of options being presented, a corresponding function can be executed by a remote server. Embodiments of the present disclosure recognize that many users interacting with an IVR system may have difficulty hearing the instructions being presented and as a result select a wrong key on the keypad when navigating the IVR menu. Moreover, if the surrounding environment is noisy, a user may not be able to hear the instructions being presented and as a result the user may be required to maintain extra amounts of focus or attention on the instructions being provided in order to correctly select the desired options being presented by the IVR system. There exists a need for a visual representation of the menu options made available by an IVR system. Having a visual guide mapping the various option pathways offered by the IVR system ameliorates accessibility concerns of users having a tough time hearing instructions, whether based on physiology or environmental circumstances. Moreover, a visual mapping of the menu options can even provide quicker navigation through the IVR menus because a user can visually see the entire menu pathway and the appropriate inputs needed to reach a desired service or function of the IVR system.

Embodiments of the present disclosure may leverage the use of multi-functional communication devices such as smart phones and other mobile communication systems, including devices capable of using voice services, visual display capabilities, internet or other types of network connectivity, DTMF codes, SMS messaging, and/or other types of signaling protocols to request a visualization of the IVR menu, and in return obtain encoded messages that lead to obtaining a visual copy of the IVR menu which can be displayed locally by the requesting device. For example, in some embodiments, the requesting device may use DTMF signals to make the request to obtain a copy of a visualization of the IVR menu. Upon the requesting device placing a voice call with the IVR system and the IVR system answering the incoming call, the requesting device can send a greeting or salutation to the IVR system in the form of a DTMG encoded message. The DTMF encoded greeting may signal multiple things to the IVR system. First, the DTMF signal of the greeting may act as a request to obtain the mapping that is visualizing the IVR menu. Secondly, DTMF code may indicate the requesting device's compliancy with various standards for receiving a visualization of the IVR menu, including compliance with the requesting device's ability to decode DTMF signals, network connectivity capabilities and/or an ability to visually display images or files. In other words, indicating to the IVR system that the requesting device is able to understand and translate DTMF codes, as well as fetch the files from the internet or other network and display them to the user of the requesting device.

An IVR application operating as part of the IVR system can receive the encoded DTMF greeting message from the requesting device, and in response may transmit a message encoding a representation of a URL describing the location of the visualized mapping of the IVR menu. In the exemplary embodiment, the form of the encoded message may be DTMF codes encoding an ASCII character set. Embodiments of the requesting device may decode the DTMF codes, translating the numerical values of the DTMF into textual information represented as an ASCII character set, revealing the URL. Embodiments of the requesting device can use the internet access (or other network capabilities) to fetch a document or file visualizing the mapping of the IVR menu from the URL location provided by the IVR system, and display the mapping of the IVR menu on a display of the requesting device, such as a screen, touchscreen, etc.

In alternative embodiments, the compliant device requesting the visualization of the IVR menu may use a combination of DTMF and a messaging protocol such as SMS to provide the location of the file or document containing the mapping of the IVR menu. For example, a compliant device enabled with a DTMF decoder, internet connectivity and visualization capabilities may place a call to an IVR system. Upon connecting to the IVR system, a IVR application hosted by the IVR system may transmit a DTMF code back to the compliant device. The transmitted DTMF codes provided by the IVR application may indicate the length of a URL describing the location of a file or document containing a visual mapping of the IVR menu. The compliant device may decode the DTMF codes into ASCII characters and in response may transmit DTMF codes back to the IVR system. The DTMF codes may encode an address such as a phone number that may be used by the IVR system to send location information for files or documents containing the visual mapping of the IVR menu. For example, a URL that can be accessed to obtain or download the files of documents containing the visual mapping of the IVR menu hosted by a remote server on a network.

Embodiments of the IVR system receiving the phone number from the compliant device may transmit a representation of the URL to the destination phone number. In the exemplary embodiment, the IVR application may transmit the representation of the URL to the phone number of the compliant device using SMS protocol for mobile telephony. Once transmitted via SMS protocol, the compliant device may receive the SMS message bearing the URL for the document or file containing the visual mapping of the IVR menu, from the IVR system. The compliant system may use internet access or other network capabilities to fetch the document or file from the URL, open the fetched file and display the visual mapping of the IVR menu to the user of the compliant device.

In some embodiments, the visual mapping of the IVR may be used by the compliant device to implement one or more additional features or functions for navigating the IVR menu. For example, in some embodiments, the compliant device accessing the visualized mapping of the IVR menu may actively track and display a user's progress amongst the IVR menu options in real-time (or near real-time) while the compliant device is inputting menu options into the IVR system. For instance, by updating the visualized mapping of the IVR menu to visually depict which part of the menu the user is currently positioned along the IVR menu workflow and previous menu option selections inputted into the IVR system that resulted in the user's current position within the IVR menu. An example of this feature may be described as a breadcrumb visual representation, which may visually represent a user's journey through the IVR menu's workflow, allowing the user to better understand their current position within the menu and help the user make additional decisions to arrive at the user's desired destination to access one or more functions of the IVR system.

In some embodiments, a compliant device may implement and provide to the user predictive routing features or functions that may be utilized alongside the visual mapping of the IVR menu. The predictive routing features may use historically learned data about the user to provide or overlay a visual representation onto the mapping of the IVR menu, suggesting a path the user could follow in order to access features or functions of the IVR system that are predicted to be useful to the user. For example, if the compliant device (or an application thereof) predicts the user may be attempting to reach a sales information voice mail box of an IVR menu based on the historical data and AI modeling of a user's profile, then when displaying the visualization of the IVR menu the compliant device may highlight the path on the IVR menu that arrives at the sales information voice mail box. Further improving the user's ability to identify a possible path to the function or feature predicted to be most useful or helpful to the user.

### Computing System

Various aspects of the present disclosure are described by narrative text, flowcharts, block diagrams of computer systems and/or block diagrams of the machine logic included in computer program product (CPP) embodiments. With respect to any flowcharts, the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices. The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination thereof.

A computer-readable storage medium should not be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation or garbage collection. However, such movement of the data during operations does not render the storage device as transitory because the data is not transitory while it is stored.

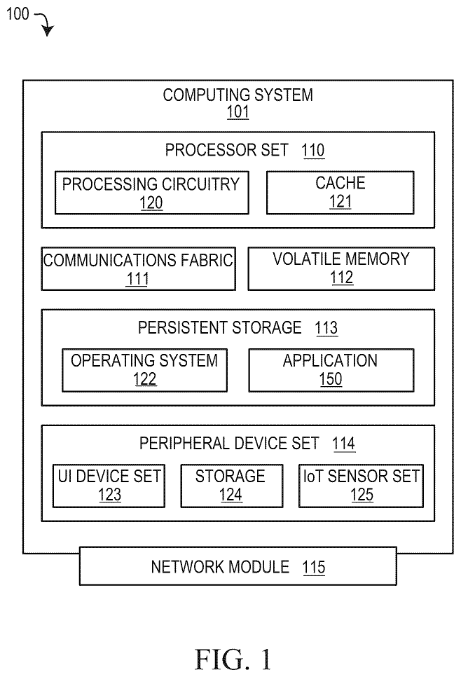

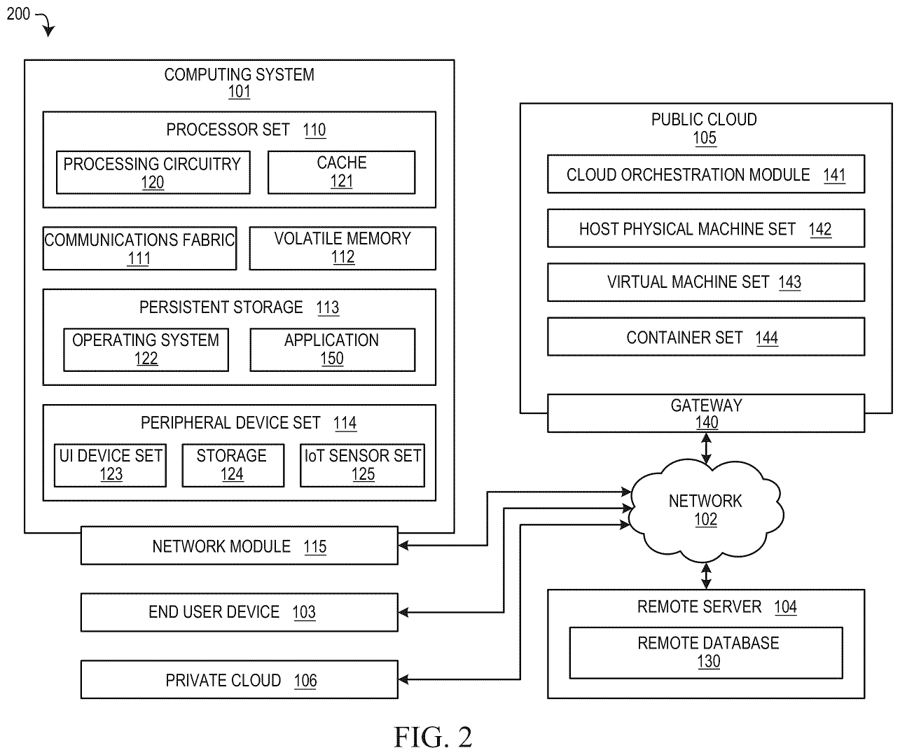

FIG. 1 illustrates a block diagram describing an embodiment of a computing system 101 operating within a computing environment 100. The computing system 101 may be a simplified example of a computing device (i.e., a physical bare metal system and/or a virtual system) capable of performing the computing operations described herein. Computing system 101 may be representative of the one or more computing systems or devices implemented in accordance with the embodiments of the present disclosure and further described below in detail. Computing system 101 as depicted in FIG. 1 (and FIG. 2) provides only an illustration of one implementation of a computing system 101 and does not imply any limitations regarding the environments in which different embodiments may be implemented. In general, the components illustrated in the computing system 101 may be representative of an electronic device, either physical or virtualized, that is capable of executing machine-readable program instructions.

Embodiments of computing system 101 may take the form of a desktop computer, laptop computer, tablet computer, smart phone or other type of mobile communications device, smart watch or other wearable computer such as a virtual reality headset, augmented reality headset, glasses or wearable accessory. Embodiments of the computing system 101 may also take the form of a mainframe computer, server, quantum computer, a non-conventional computer system such as an autonomous vehicle or home appliance, and/or any other form of computer or mobile device now known or to be developed in the future that is capable of running an application 150, accessing a network 102 or querying a database, such as remote database 130. Performance of a computer-implemented method executed by a computing system 101 may be distributed among multiple computers and/or between multiple locations. Computing system 101 may be located as part of a cloud network, even though it is not shown within a cloud in FIGS. 1-2. Moreover, computing system 101 is not required to be part of a cloud network except to any extent as may be affirmatively indicated.

Processor set 110 can include one or more computer processors of any type now known or to be developed in the future. Processing circuitry 120 may be distributed over multiple packages. For example, multiple, coordinated integrated circuit chips. Processing circuitry 120 may implement multiple processor threads and/or multiple processor cores. Cache 121 may refer to memory that is located on the processor chip package(s) and/or may be used for data or code that can be made available for rapid access by the threads or cores running on processor set 110. Cache 121 memories can be organized into multiple levels depending upon relative proximity to the processing circuitry 120. Alternatively, some, or all of cache 121 of processor set 110 may be located “off chip.” In some computing environments, processor set 110 may be designed for working with qubits and performing quantum computing.

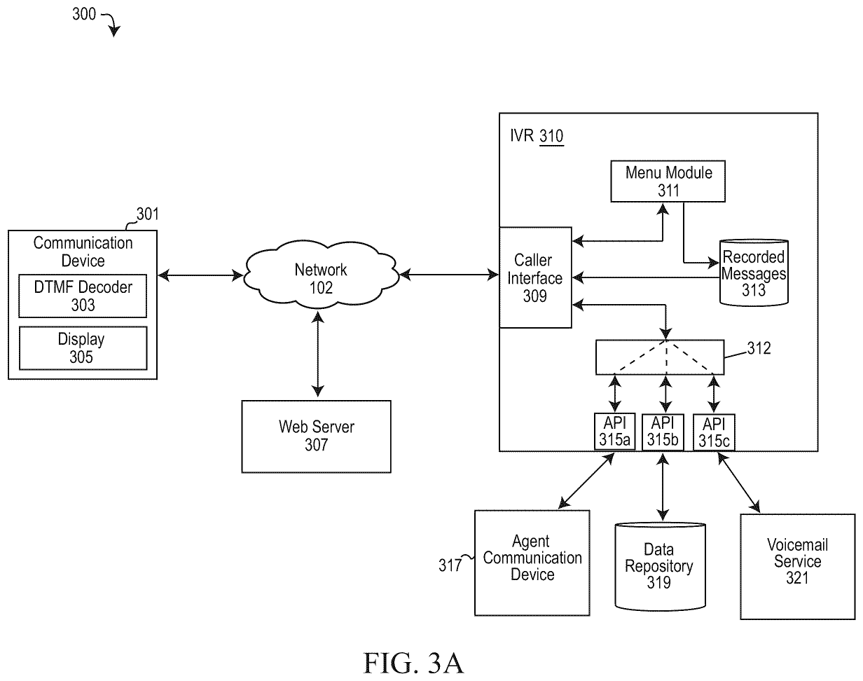

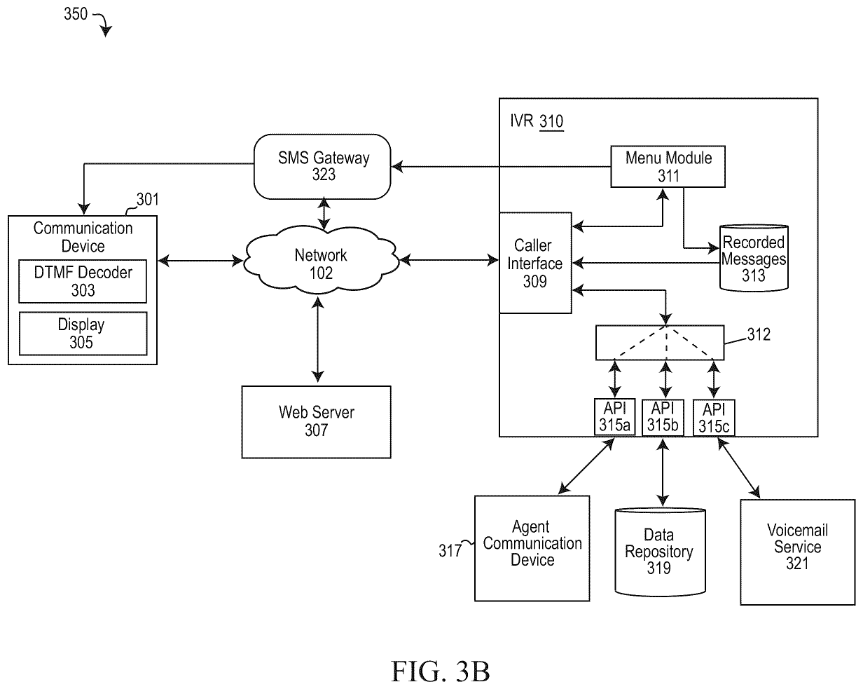

Computer readable program instructions can be loaded onto computing system 101 to cause a series of operational steps to be performed by processor set 110 of computing system 101 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 121 and the other storage media discussed herein. The program instructions, and associated data, can be accessed by processor set 110 to control and direct performance of the inventive methods. In computing environments of FIGS. 1-2, at least some of the instructions for performing the inventive methods may be stored in persistent storage 113, volatile memory 112, and/or cache 121, as application(s) 150 comprising one or more running processes, services, programs and installed components thereof. For example, program instructions, processes, services and installed components thereof may include DTMF decoder 303, caller interface 309, menu module 311, one or more APIs 315a-315c providing third party services and data to IVR 310 and/or IVR application(s) or software running on an IVR 310 system (as shown in FIG. 3A-3B). The term “module” as used herein, may refer to hardware, software, or a module may be a combination of hardware and software resources. For example, embodiments of a menu module 311 may be a combination of a hardware-based module and/or a software-based module. A hardware-based module may include self-contained components such as chipsets, specialized circuitry, one or more memory devices and/or persistent storage 113. Whereas a software-based module may be part of a program, program code or linked to program code containing specific programmed instructions loaded into a memory device or persistent storage 113 device of one or more computing systems 101 operating as part of the computing environment.

Communications fabric 111 may refer to signal conduction paths that may allow the various components of computing system 101 to communicate with each other. For example, communications fabric 111 can provide for electronic communication among the processor set 110, volatile memory 112, persistent storage 113, peripheral device set 114 and/or network module 115. Communications fabric 111 can be made of switches and electrically conductive paths that make up busses, bridges, physical input/output ports and the like. Other types of signal communication paths may be used, such as fiber optic communication paths and/or wireless communication paths.

Volatile memory 112 may refer to any type of volatile memory now known or to be developed in the future, and may be characterized by random access, but this is not required unless affirmatively indicated. Examples include dynamic type random access memory (RAM) or static type RAM. In computing system 101, the volatile memory 112 is located in a single package and can be internal to computing system 101, but, alternatively or additionally, the volatile memory 112 may be distributed over multiple packages and/or located externally with respect to computing system 101. Application 150, along with any program(s), processes, services, and installed components thereof, described herein, may be stored in volatile memory 112 and/or persistent storage 113 for execution and/or access by one or more of the respective processor sets 110 of the computing system 101.

Persistent storage 113 can be any form of non-volatile storage for computers that may be currently known or developed in the future. The non-volatility of this storage means that the stored data may be maintained regardless of whether power is being supplied to computing system 101 and/or directly to persistent storage 113. Persistent storage 113 may be a read only memory (ROM), however, at least a portion of the persistent storage 113 may allow writing of data, deletion of data and/or re-writing of data. Some forms of persistent storage 113 may include magnetic disks, solid-state storage devices, hard drives, flash-based memory, erasable read-only memories (EPROM) and semi-conductor storage devices. Operating system 122 may take several forms, such as various known proprietary operating systems or open-source Portable Operating System Interface type operating systems that employ a kernel.

Peripheral device set 114 includes one or more peripheral devices connected to computing system 101. For example, via an input/output (I/O interface). Data communication connections between the peripheral devices and the other components of computing system 101 may be implemented using various methods. For example, through connections using Bluetooth, Near-Field Communication (NFC), wired connections or cables (such as universal serial bus (USB) type cables), insertion type connections (for example, secure digital (SD) card), connections made though local area communication networks and/or wide area networks such as the internet. In various embodiments, UI device set 123 may include components such as a display screen, speaker, microphone, wearable devices (such as glasses, googles, headsets, smart watches, clip-on, stick-on or other attachable devices), keyboard, mouse, joystick, printer, touchpad, game controllers, and haptic feedback devices. Storage 124 can include external storage, such as an external hard drive, or insertable storage, such as an SD card. Storage 124 may be persistent and/or volatile. In some embodiments, storage 124 may take the form of a quantum computing storage device for storing data in the form of qubits. In some embodiments, networks of computing systems 101 may utilize clustered computing and/or utilize storage components as a single pool of seamless resources when accessed through a network by one or more computing systems 101. For example, a storage area network (SAN) that is shared by multiple, geographically distributed computing systems 101 or network-attached storage (NAS) applications. IoT sensor set 125 can be made up of sensors that can be used in Internet-of-Things applications. For example, a sensor may be a temperature sensor, motion sensor, light sensor, infrared sensor or any other type of known sensor type.

Network module 115 may include a collection of computer software, hardware, and/or firmware that allows computing system 101 to communicate with other computer systems through a computer network 102, such as a LAN or WAN. Network module 115 may include hardware, such as modems or Wi-Fi signal transceivers, software for packetizing and/or de-packetizing data for communication network transmission, and/or web browser software for communicating data over the network. In some embodiments, network control functions and network forwarding functions of network module 115 are performed on the same physical hardware device. In other embodiments (for example, embodiments that utilize software-defined networking (SDN)), the control functions and the forwarding functions of network module 115 can be performed on physically separate devices, such that the control functions manage several different network hardware devices or computing systems 101. Computer readable program instructions for performing the inventive methods can be downloaded to computing system 101 from an external computer or external storage device through a network adapter card or network interface which may be included as part of network module 115.

FIG. 2 depicts a computing environment 200 which may be an extension of the computing environment 100 of FIG. 1, operating as part of a network 102. In addition to computing system 101, computing environment 200 can include a computing network 102 such as a wide area network (WAN) (or another type of computer network) connecting computing system 101 to one or more end user device (EUD) 103, remote server 104, public cloud 105, and/or private cloud 106. In this embodiment, computing system 101 includes processor set 110 (including processing circuitry 120 and cache 121), communication fabric 111, volatile memory 112, persistent storage 113 (including operating system 122 and application(s) 150, as identified above), peripheral device set 114 (including user interface (UI) device set 123, storage 124, Internet of Things (IoT) sensor set 125), and network module 115. Remote server 104 includes remote database 130. Public cloud 105 can include gateway 140, cloud orchestration module 141, host physical machine set 142, virtual machine set 143, and/or container set 144.

Network 102 may be comprised of wired or wireless connections. For example, connections may be comprised of computer hardware such as copper transmission cables, optical transmission fibers, wireless transmission, routers, firewalls, switches, gateway computers and/or edge servers. Network 102 may be described as any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. Other types of networks that can be used to interconnect the various computing systems 101, end user devices 103, remote servers 104, private cloud 106 and/or public cloud 105 may include Wireless Local Area Networks (WLANs), home area network (HAN), cellular networks, backbone networks (BBN), peer to peer networks (P2P), campus networks, enterprise networks, the Internet, single tenant or multi-tenant cloud computing networks, the Public Switched Telephone Network (PSTN), and any other network or network topology known by a person skilled in the art to interconnect computing system 101.

End user device 103 can include any computer device that can be used and/or controlled by an end user (for example, a customer of an enterprise that operates computing system 101) and may take any of the forms discussed above in connection with computing system 101. EUD 103 may receive helpful and useful data from the operations of computing system 101. For example, in a hypothetical case where computing system 101 is designed to provide a recommendation to an end user, this recommendation may be communicated from network module 115 of computing system 101 through network 102 to EUD 103. In this example, EUD 103 can display, or otherwise present, the recommendation to an end user. In some embodiments, EUD 103 may be a client device, such as thin client, thick client, mobile computing device such as a smart phone, mainframe computer, desktop computer and so on.

Remote server 104 may be any computing system that serves at least some data and/or functionality to computing system 101. Remote server 104 may be controlled and used by the same entity that operates computing system 101. Remote server 104 represents the machine(s) that collect and store helpful and useful data for use by other computers, such as computing system 101. For example, in a hypothetical case where computing system 101 is designed and programmed to provide a recommendation based on historical data, the historical data may be provided to computing system 101 from remote database 130 of remote server 104.

Public cloud 105 may be any computing systems available for use by multiple entities that provide on-demand availability of computer system resources and/or other computer capabilities including data storage (cloud storage) and computing power, without direct active management by the user. The direct and active management of the computing resources of public cloud 105 can be performed by the computer hardware and/or software of cloud orchestration module 141. The computing resources provided by public cloud 105 can be implemented by virtual computing environments that run on various computers making up the computers of host physical machine set 142, and/or the universe of physical computers in and/or available to public cloud 105. The virtual computing environments (VCEs) may take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through network 102.

VCEs can be stored as “images.” A new active instance of the VCE can be instantiated from the image. Two types of VCEs may include virtual machines and containers. A container is a VCE that uses operating-system-level virtualization, in which the kernel allows the existence of multiple isolated user-space instances, called containers. These isolated user-space instances may behave as physical computers from the point of view of applications 150 running in them. An application 150 running on an operating system 122 can utilize all resources of that computer, such as connected devices, files and folders, network shares, CPU power, and quantifiable hardware capabilities. Applications 150 running inside a container of container set 144 may only use the contents of the container and devices assigned to the container, a feature which may be referred to as containerization.

Private cloud 106 may be similar to public cloud 105, except that the computing resources may only be available for use by a single enterprise. While private cloud 106 is depicted as being in communication with network 102 (such as the Internet), in other embodiments a private cloud 106 may be disconnected from the internet entirely and only accessible through a local/private network. A hybrid cloud may refer to a composition of multiple clouds of different types (for example, private, community or public cloud types), and the plurality of clouds may be implemented or operated by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 may be both part of a larger hybrid cloud environment.

### System for Visualizing Menu Options of an Ivr System

It will be readily understood that the instant components, as generally described and illustrated in the Figures herein, may be arranged and designed in a wide variety of different configurations. Accordingly, the following detailed description of the embodiments of at least one of a method, apparatus, non-transitory computer readable medium and system, as represented in the attached Figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the Figures, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Referring to the drawings, FIGS. 3A-3B depict embodiments of a computing environment 300, 350 illustrating systems capable of requesting, transmitting, receiving and/or displaying a visual mapping of IVR menu options provided by an IVR system 310 (referred to herein as IVR 310), which may be accessed using an EUD 103 such as communication device 301 shown in FIGS. 3A-3B. As shown in FIG. 3A, embodiments of the computing environment 300 can include one or more communication device 301 (or other types of EUD 103), web server 307 (or any other type of remote server 104), and IVR 310. Communication device 301, IVR 310 and web server 307 may be placed in communication with one another via a network 102. Similarly, in the alternative embodiment of computing environment 350, the system includes the communication device 301, IVR 310 and web server 307 all placed in communication with one another via network 102. However, in addition to the computing systems of the environment 300 shown in FIG. 3A, the computing environment 350 may further include an SMS gateway 323 which may act as bridge between one or more messaging systems of a mobile communication network and other communication networks such as network 102; enabling communication devices 301 and IVR 310 to route text-based messages back and forth.

Communication device(s) 301 may be any type of computing system 101 that is able to establish connections with IVR 310. For example, by dialing a phone number associated with the IVR 310. A call can be placed by the communication device 301 using public switched telephone networks (PSTN), voice-over internet protocol (VOIP), mobile networks or other broadband network communication protocols to connect with IVR 310. Once a connection is established between communication device 301 and IVR 310, the connected communication device(s) 301 and IVR 310 may proceed with sending encoded messages back and forth via the network 102. Encoded messages can include auditory signals indicating commands, requests and/or locations of files or documents containing visual mappings of the IVR 310 menu options.

Communication device 301 may be equipped with a DTMF decoder 303 which may be capable of decoding auditory signals such as DTMF tones provided by IVR 310. DTMF decoder 303 may decode DTMF tones provided by IVR 310 by analyzing the received DTMF signal to determine the frequencies of the two tones. Analysis may be performed using a filter bank to separate the received signal into several frequency bands, and then analyzing the energy in each band to determine which two tones are present. Once the two tones have been identified, the DTMF decoder 303 may use a lookup table to determine which symbol each of the two tones being received represent. The lookup table maps each combination of two frequencies to a specific symbol, such as a digit, letter, or other symbol. In some embodiments, in order to ensure reliable decoding, the DTMF decoder 303 may further employ one or more error-correction techniques, such as checking the duration of each tone and the ratio of the energies of the two tones, to ensure that they match the expected values for a valid DTMF signal.

Embodiments of communication devices 301 may be equipped with internet or other network connectivity capabilities. Communication devices 301 may utilize network connection capabilities to retrieve files from one or more host location(s) which may be decoded from DTMF tones provided by IVR 310. For example, the decoded messages obtained from the DTMF tones provided by IVR 310 may be decoded into a character set comprising a representation of a URL in text format. The URL may indicate one or more computer systems connected to network 102, from which communication device can fetch the file comprising the visual mappings of the IVR 310 menu options. For example, the file host may be a remote server 104, public cloud 105, private cloud 106 or other type of network-accessible system. In the example of the system depicted in FIG. 3A-3B, web server 307 may be the host of the file containing the visual mapping of the IVR menu options.

Embodiments of communication device 301 may further be equipped with a capability to display visual mappings of IVR menu options. Display 305 can be any type of computer output device that may be able to visualize information generated, stored, or accessed by communication device 301. Display 305 may be able to display information in the form of text, images and video. Display 305 may include any type of computer display, including but not limited to touchscreen displays, organic light emitting diodes (OLED), light emitting diodes (LED), liquid crystal display (LCD), etc. Communication device 301 may display contents of the file containing the visual mapping of IVR options from a locally stored copy of the file and/or remotely via network 102. Once displayed by display 305, a user can simultaneously visually view menu option pathways of the IVR 310, while also being able to listen to pre-recorded messages and instructions provided by the IVR 310 on an audio channel formed by the connection between communication device 301 and IVR 310. Using the visual mapping of the IVR menu options and/or the auditory instructions and recorded messages, communication device 301 may be equipped with the ability to transmit menu option selections to the IVR 310 using DTMF tones. Subsequently, IVR 310 receiving the selections of the communication device 301 as DTMF tones, decodes the tones and executes the selected functions, provides requested data or information associated with the content selected by the communication device 301 and/or connects the communication device 301 with a live agent of the IVR 310.

Embodiments of IVR 310 may be described as a system that allows a computing system 101 to interact with human users of a communication device 301 in order access different types of information, data, functions or services provided by IVR 310 and/or facilitate connections between the user and other live humans or agents. Human users of communication device 301 can interact with IVR 310 using voice and/or DTMF inputs that may be entered into the communication device 301 via a keypad or keyboard (real or virtual). IVR systems 310 can provide a wide range of services, including account information, balance inquiries, order tracking, and problem resolution. They can also be used to automate tasks such as appointment scheduling, payment processing, and survey taking. By automating routine tasks, IVR systems can help call centers to improve efficiency and reduce wait times for customers. Embodiments of IVR 310 may be integrated with other technologies, including databases, voice recognition systems and even speech analytics systems which can analyze user interactions and provide insights into user behaviors or preferences.

Embodiments of IVR 310 as shown in FIGS. 3A-3B may comprise a plurality of components, which may each perform a particular task or function of IVR 310. For example, IVR 310 may include a caller interface 309, menu module 311, recorded messages database 313 (referred to herein as recorded messages 313), call router 312 and/or one or more application programming interface (API) 315a-315c (referred to herein generally as API 315) connecting IVR customers to additional functions, services, data or communication channels. For example, call router 312 can connect the user of communication device 301 via an API 315 to an agent communication device 317, data repository 319 and/or voicemail service 321.

Caller interface 309 of IVR 310 may be the interface though which a customer, such as a user of communication device 301, interacts with IVR 310 via an established voice connection or audio channel. The caller interface 309 can provide a way for users that are connected via communication device 301 to access the information, services and functions provided by IVR 310. Caller interface 309 may provide voice prompts to guide the user through the IVR menu, respond to DTMF inputs provided to IVR 310 by communication device 301, and output a combination of recorded messages 313, stored data, information, and/or connect users to one or more functions and features of IVR 310; such as live agent voice chat and voicemail services 321. Caller interface 309 may receive DTMF tones from communication device 301, decode the incoming DTMF tones as a selection of options from the IVR menu and/or a request that signals the IVR 310 to provide additional information to the user about a location of files containing visual mappings of the IVR menu options. One or more components of IVR 310, such as the menu module 311 decodes the DTMF tones, identifies what a user is requesting, and in response to the request selects an action, such as providing a recorded message 313 back to the user via call interface 309, transmitting DTMF tones back to the communication device 301, and/or routing the call from communication device 301 to a service or function of IVR 310 via call router 312. For example, as a user makes menu selections based on the IVR menu options, caller interface 309 may transmit the selections provided as DTMF tones to menu module 311 for decoding and decision-making processes of IVR 310. Upon decoding the DTMF and identifying menu option selections, IVR 310 can play the recorded messages 313 back to the user via caller interface 309, pass the menu selections along to call router 312 and/or respond to requests transmitted by the communication device 301.

Embodiments of call router 312 may perform the tasks, functions and/or processes of IVR 310 responsible for connecting communication device 301 with the functions or services provided by IVR 310, based on the selection of IVR menu options (or a series of menu option selections) inputted at the caller interface 309. For example, IVR menu option selections inputted using DTMF tones, Transport Of Reduced References In Dtmf (TORRID) protocol, t.xx FAX standards, or any other protocols that may be decodable and understood by menu module 311 of IVR 310. Based on the IVR menu option selections decoded by the menu module 311, call router 312 may call a corresponding API 315 to deliver the selected services or functions to communication device 301 via IVR 310. For instance, a user inputting a sequence of DTMF tones to request to speak with a live human agent over a voice channel may be routed by call router 312 to an agent communication device 317 via API 315a. Likewise, a user inputting a sequence of DTMF tones requesting to look up or receive data, such as account information, order information, pre-recorded technical support, etc., may be routed by call router 312 to one or more databases containing the data or information, such as data repository 319, which may be reached by calling API 315b as depicted in FIGS. 3A-3B. Moreover, in situations where a user inputs one or more DTMF tones indicating a request to be connected to leave a voicemail with a particular business unit or individual, the communication device may be routed by call router 312 to a voicemail service 321 via API 315c, allowing the user to transmit and record a voice message using communication device 301.

Embodiments of menu module 311 may perform tasks, functions and/or processes of IVR 310 associated with decoding incoming signals and requests from communication devices 301 connecting to IVR 310, maintaining IVR menu options, correlating incoming requests and menu option selections to the available IVR menu options and instructing IVR 310 how to respond to the incoming signals and communications being received at the caller interface 309. For example, menu module 311 may decode incoming DTMF tones, correlate the tones to menu option selections for a particular function or service provided by IVR 310 and instruct IVR 310 to route the call to the service or function and/or playback pre-recorded audio content requested by the DTMF tones from the recorded messages 313 database.

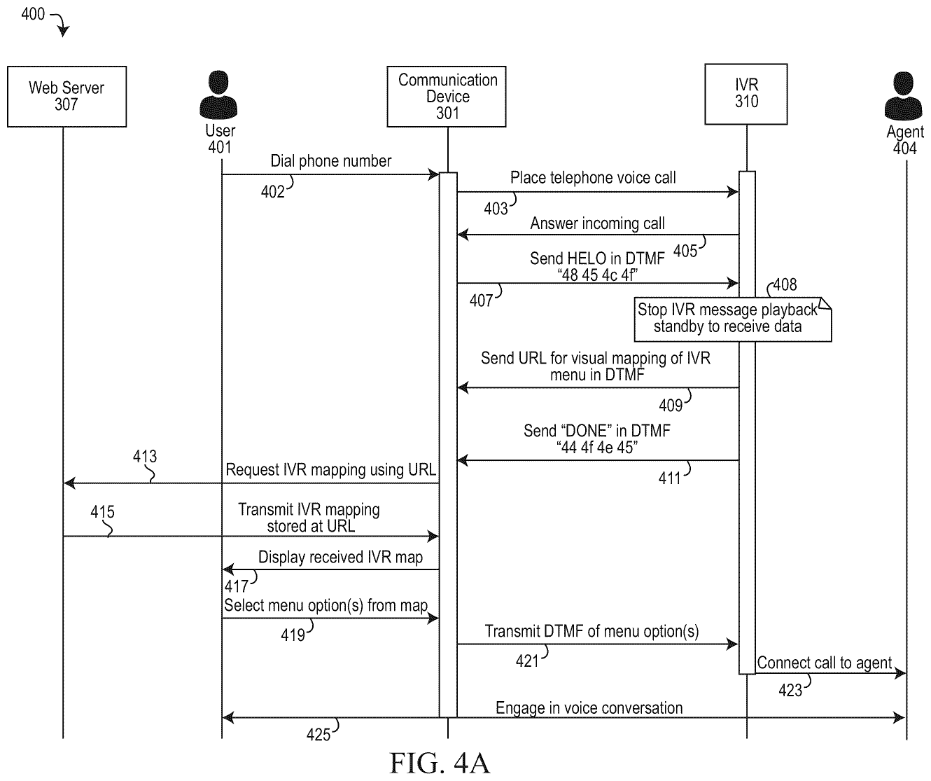

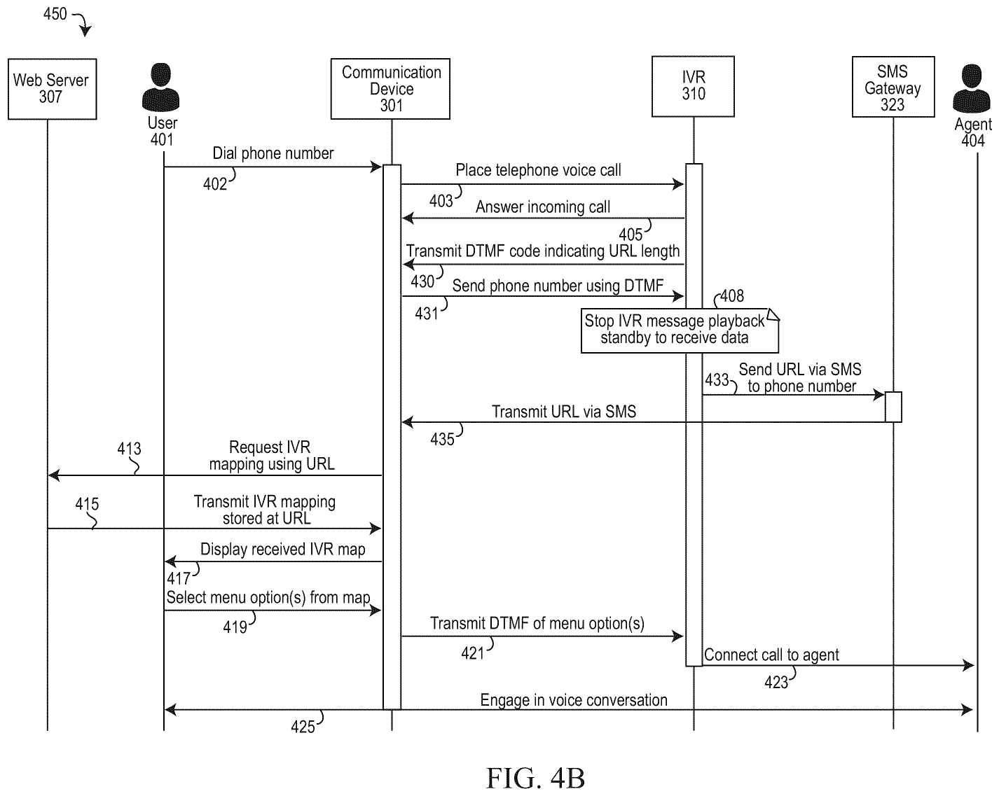

In some embodiments of IVR 310, menu module 311 may decode incoming messages containing DTMF tones (or other messaging protocols) from communication device 301 that may be requesting access to visual mappings of an IVR menu options that are available to IVR 310. Embodiments of menu module 311 may include hardware components and/or underlying software resources to perform the one or more tasks, and functions of the menu module 311. For example, one or more IVR applications which may coordinate responses to requests for access to the visual mappings of IVR menu options by using DTMF tones, TORRID protocols or other data transmission protocols to encode an ASCII character set representing location information describing where communication device 301 may access the file or documents containing the visual mappings of IVR menu options. FIG. 4A illustrates an embodiment of a sequence 400 for fulfilling a request to access a visual mapping of the IVR menu options using a combination DTMF tones and internet-connectivity of the communication device 301.

As depicted by sequence 400 in FIG. 4A, the sequence 400 may begin when a user 401 at step 402 dials a phone number associated with IVR 310 on communication device 301. Using the inputted phone number, communication device 301 places the voice call with IVR 310 in step 403. If IVR 310 answers the incoming call, a connection is established between communication device 301 and IVR 310. In step 407, communication device 301 transmits a greeting or message to IVR 310 indicating the request for the information about the location of the visual mapping of IVR menu options. In the example of sequence 400, the greeting message “H-E-L-O” is transmitted in the DTMF tones mapped to the hexadecimal code “48, 45, 4c, 4f” to IVR 310. The incoming message received by IVR 310, can be decoded by menu module 311 back into the ASCII character set for the word “H-E-L-O” and may indicate a plurality of things to the IVR system. The greeting or request message may indicate to IVR 310 that communication device 301 is compliant with transmitting and decoding DTMF tones (or other messaging protocols via the open communication channel); the communication device 301 is compliant with visual capabilities that may be needed to display the visual mapping of the IVR menu options; and/or communication device 301 is enabled with internet or other network connectivity capabilities that allow communication device 301 to fetch the files containing the visual mapping of IVR menu options.

Hexadecimal values can be mapped to DTMF tones by converting the hexadecimal values to decimal values, followed by mapping the decimal values to DTMF tones. For example, hexadecimal value 4f is equal to 79 in decimal. In the DTMF system, the digit 7 is represented by a low frequency of 770 Hz and a high frequency tone of 1633 Hz. An IVR application of the menu module may map “4f” to the DTMF tone representing digit 7. However, this mapping may not be unique and can vary depending on the specific application being used. Applications used by communication device 301 and IVR 310 for encoding and decoding messages ASCII character sets as DTMF signals can be done by using the same mapping. In the Example above, the DTMF tones mapped to hexadecimal “48, 45, 4c, 4f” for the greeting “H-E-L-O” should be the same for both underlying applications and/or services used by the communication device 301 and IVR 310 to encode and decode DTMF signals into ASCI character sets.

Upon receiving the greeting or request message in step 407, menu module 311 of IVR 310 may stop or halt playback of pre-recorded messages or instructions being outputted to communication device 301 via call interface 309. IVR 310 may be placed into a standby mode for data receipt and/or transmission. In response to the request of the greeting message, step 409 of sequence 400 may commence, whereby menu module 311 may transmit DTMF tones of a message encoding an ASCII character set representing a URL the communication device 301 can use to access the file containing the visual mapping of IVR menu options. In alternative embodiments, the menu module 311 and communication device 301 may use a different transmission protocol to deliver the message comprising an encoded ASCII character set. For example, menu module 311 may encode the ASCII character set of the URL using TORRID protocol to compress the message being sent using the DTMF tones. TORRID is a protocol that works using serialization/deserialization to remove the highest order most-significant bit in an 8-bit sequence so that the resulting bit stream is compressed and packed by ⅛th. This is useful when the source data is encoded in a codepage that uses less than 8 bits for its full representation, such as an ASCII character encoding. The resulting decimal being encoded into binary would result in the highest order bit to always be zero. Since this always is the case, TORRID uses this fact to compress the encoding prior to transmission and decoding at the receiving end. In other words, TORRID is a bit-packing technique.

The TORRID protocol takes the 8-bit binary-coded-decimal (BCD) representing the ASCII character set and copies the 7 lowest-order (right-most) bits into the transmission, thus every for 8 characters being transmitted can be done with only 7 bytes. Allowing for a URL to be transmitted in the form of DTMF sequences of a serialized 7-bit ASCII. The following is a sample transmission of characters (i.e., ABCDEFGH in the example below) over DTMF using TORRID encoding in five steps depicted below:
1. ASCII encoding step

| A | B | C | D | E | F | G | H |
|---|---|---|---|---|---|---|---|
| 0x40 | 0x41 | 0x42 | 0x43 | 0x44 | 0x45 | 0x46 | 0x47 |
| 01000001 | 01000010 | 01000011 | 01000100 | 01000101 | 01000110 | 01000111 | 01001000 |

2. Packing step (remove the leading zero) compresses the message into 7 bytes instead of 8

| A | B | C | D | E | F | G | H |
|---|---|---|---|---|---|---|---|
| 1000001 | 1000010 | 1000011 | 1000100 | 1000101 | 1000110 | 1000111 | 1001000 |
| 10000011 | 00001010 | 00011100 | 01001000 | 10110001 | 10100011 | 11001000 | |
| 0x83 | 0x0a | 0x1c | 0x48 | 0xb1 | 0xa3 | 0xc8 | |

3. Transmission over DTMF as “830ac 148bla3c8” instead of “4041424344454647” as shown by the encoding step of step 1 before packing.
4. Unpacking step (adds a zero every 7^{th} bit)

| A | B | C | D | E | F | G | H |
|---|---|---|---|---|---|---|---|
| 0x83 | 0x0a | 0x1c | 0x48 | 0xb1 | 0xa3 | 0xc8 | |
| 1000001 | 1000010 | 1000011 | 1000100 | 1000101 | 1000110 | 1000111 | |
| 01000001 | 01000010 | 01000011 | 01000100 | 01000101 | 01000110 | 01000111 | 01001000 |

5. ASCII decoding step

| A | B | C | D | E | F | G | H |
|---|---|---|---|---|---|---|---|
| 01000001 | 01000010 | 01000011 | 01000100 | 01000101 | 01000110 | 01000111 | 01001000 |
| 0x40 | 0x41 | 0x42 | 0x43 | 0x44 | 0x45 | 0x46 | 0x47 |

In step 411 of sequence 400, upon completion of the transmission of the URL providing a location of the file containing the visual mapping of the IVR menu options to communication device 301, IVR 310 may transmit an encoded message indicating to communication device that URL message transmission has completed. For example, in sequence 400, menu module 311 may generate an ASCII encoded character set for “DONE” in DTMF, TORRID or another transmission protocol. As shown in sequence 400, the message ‘DONE” can be sent by encoding ASCII characters as hexadecimal codes “44, 4f, 4e, 45” which can be mapped to the DTMF tones transmitted by IVR 310. The DTMF decoder 303 of communication device 301 decodes the incoming DTMF tones back into hexadecimal according to mappings stored by DTMF decoder 303 and translates the hexadecimal code “44, 4f, 4e, 45” into the ASCII characters D-O-N-E, signaling to communication device 301 that the completed URL has been transmitted.

In some embodiments, encoded messages being transmitted between communication device 301 and IVR 310 may performed using signals compliant with T.xx FAX standards. The most common T.xx FAX standards that may be used may include T.37, T.38, T.30, T.4 and T.6. Unlike DTMF tones which are designed to be resistant to noise, in embodiments wherein a T.xx standard is used instead, communication device 301 and/or IVR 310 may disable the microphone of the communication device to prevent noise during transmission of the encoded message. Moreover, instead of communicating a word such as “DONE” as discussed in the embodiment above which uses DTMF tones, a transmission that employs a T.xx standard my indicate end-of-transmission has been reached using T.30 standards.

Although not pictured in sequence 400, in some embodiments, sequence 400 may include a verification step. During the verification step, upon indication by IVR 310 that the data stream of the URL has completed (i.e., by transmitting a message with containing an ASCII encoded word such as “DONE”), communication device 301 may responsively transmit an ASCII encoded message requesting verification of the document or file located at the URL previously transmitted by IVR 310. For example, communication device 301 may transmit a message encoded for the word “VRFY” and transmit the message to IVR 310 using DTMF tones. Upon decoding the “VRFY” message, an ASCII encoded message representing a 128 bit MD5 hash of the file containing the visual mapping of the IVR menu options is transmitted to the communication device 301. In the example where the hash is a 128-bit hash, IVR 310 transmits the hash in 16 DTMF tones. Since the full hash is 128bits, when 128bits are divided by 8-bits encoded for each ASCII character per DTMF tone, that equals 16 DTMF tones to deliver all ASCII characters of the MD5 hash. Embodiments of IVR 310 may not be required to further transmit a termination word indicating to the conclusion of the transmission of the MD5 hash for the file. Unlike a URL which can be any length of characters in size, the hash being transmitted to communication device 301 is a known length. Therefore, upon receipt of the 16th DTMF tone, the communication device 301 may automatically know that the message encoding the hash of the file has completed transmission. Once communication device 301 accesses the file using the provided URL, communication device 301 can download the file, compute the MD5 hash of the downloaded file and compare it to the MD5 hash provided by IVR 310 to confirm that the hashes match.

Continuing with the description of sequence 400 as depicted in in FIG. 4A, during step 413, communication device 301 may use its internet connectivity or other network capabilities to retrieve the file containing the visual mapping of the IVR menu options using the decoded ASCII character set representing a URL that was transmitted by IVR 310. For example, communication device 301 may input the ASCII character set representing the URL into a web browser or other type of thin client to connect communication device to the web server 307 or other type of host computing system such as a remote server 104 storing the file and request the file containing the visual representation of the IVR menu options. Communication device 301 may request access to a copy of the file at the file location provided by IVR 310 by transmitting a request over a TCP/IP connection using a transfer protocol such as HTTP, HTTPS, FTP, FTPS, SFTP, SCP, or another type of known transfer protocol sent to the computer system hosting the file. In response to the request made in step 413, in step 415 of the sequence 400, the computer system hosting the file containing the visual mapping of the IVR menu options is transmitted or streamed from the host system (i.e., web server 307 in the example of FIG. 4A) to the communication device 301. Embodiments of communication device 301 may open the file containing the visual mapping of the IVR menu options and in step 417, communication device 301 may visually depict the visual mapping on display 305 for the user to view.

A communication device 301 displaying a visual mapping of IVR menu options may allow a user to simultaneously view all available services and functions provided by an IVR 310 while the communication device 301 remains connected to IVR 310. This allows a user to decide which functions or services of IVR 310 a user would like to access and plot a pathway of menu options to select and the inputs that may be needed to express those menu option selections to IVR 310, in order to receive the desired services or function of IVR 310. These steps are shown in sequence 400 via step 419 and step 421. In step 419, a user selects one or more menu options from the visual mapping of IVR menu options. The visual mapping may indicate which type of input a user should enter into the communication device 301 in order to express the user's selections. For example, the visual mapping of the IVR menu options may include numbers and/or symbols corresponding to a keyboard or keypad of the communication device 301, and at each layer of the IVR menu, the menu options each have a unique number or symbol for making a menu option selection. In response to the user's sequence of inputs on the keyboard or keypad, during step 421 of sequence 400, communication device 301 communicates the selected menu options to IVR 310 by sequentially transmitting DTMF tones that are mapped to the corresponding number or symbol on the keyboard or keypad for each of the menu options selected by the user. Once the DTMF tones are decoded by IVR 310 (i.e., by menu module 311), IVR 310 may proceed to the next layer of the IVR menu, playback menu options and/or deliver the requested service, function, data, etc. to communication device 301. In the example provided in sequence 400, the user is shown to have requested to speak to an agent 404, whereby IVR 310 connects communication device 301 to a communication device operated by agent 404 (in step 423) and as a result a voice channel is opened in step 425 enabling the user 401 and agent 404 to engage in voice conversation.

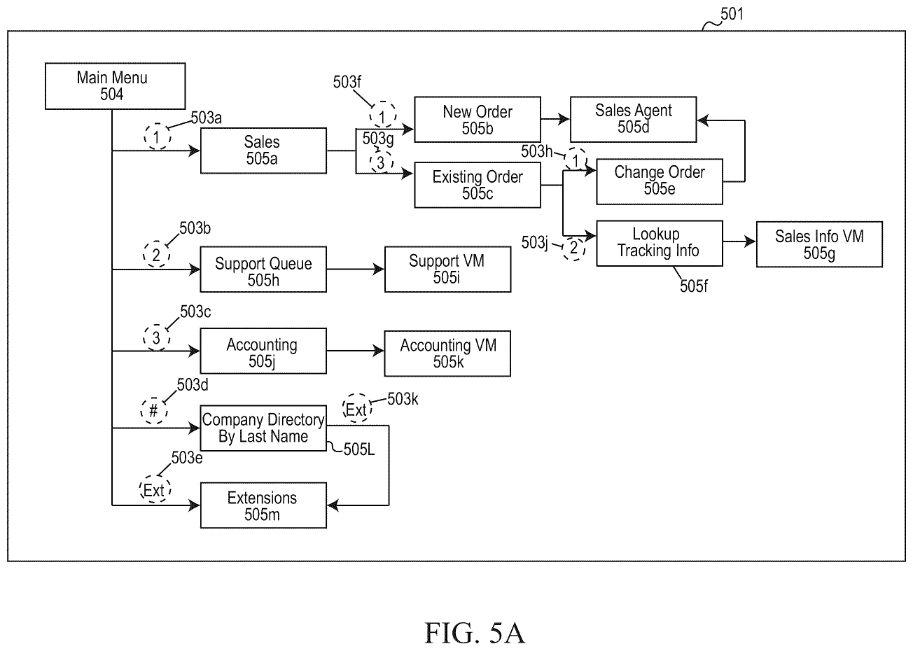

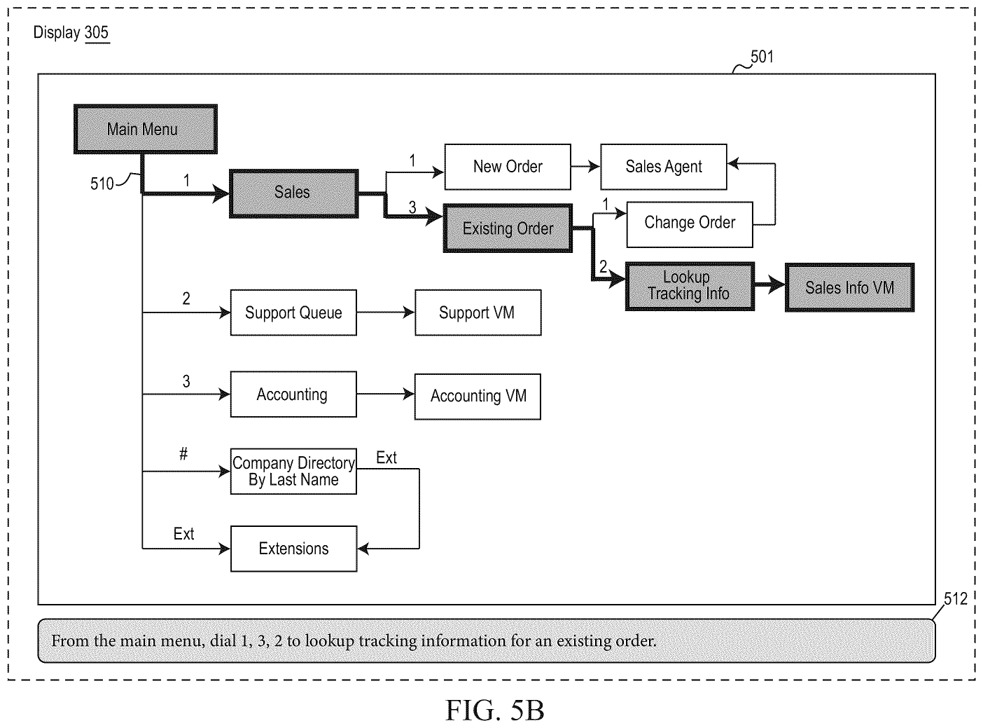

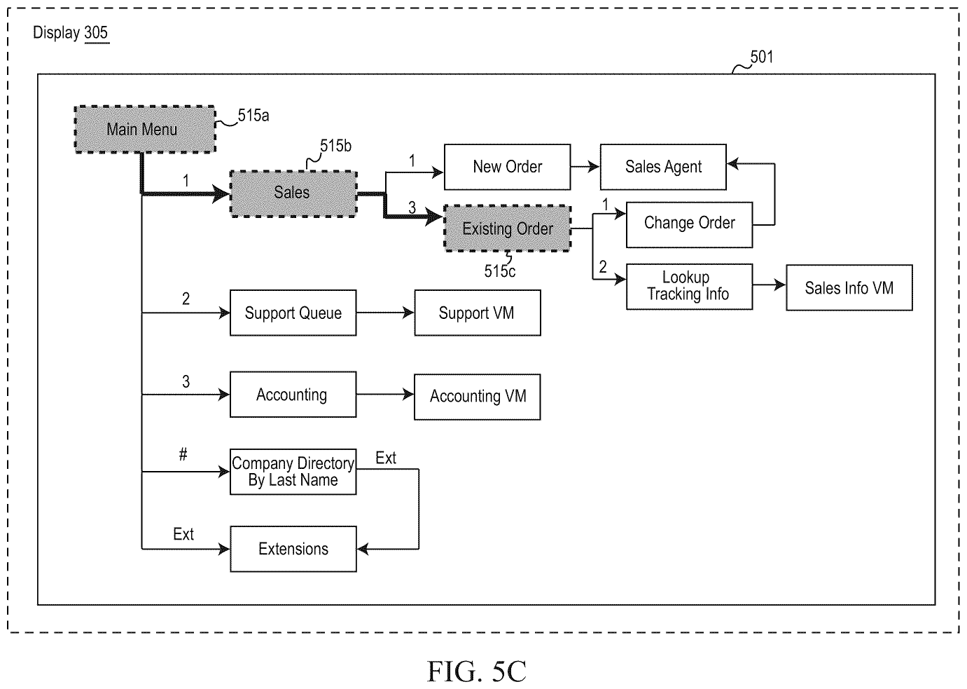

FIG. 5A depicts an example embodiment of a visual mapping 501 of an IVR menu. The IVR menu comprises a plurality of menu options 505a-505m (referred to generally as menu options 505). Visual mappings of IVR menu options may be more complex or less complex than the visual mapping 501 depicted in FIG. 5A. The amount and type of options that may be presented as part of the visual mapping of IVR menu options may vary depending on the services and functions provided to users of IVR 310. Embodiments of the visual mappings of IVR menus may be multi-level IVR menus, wherein multiple layers of menu options 505 are available for selections as depicted by visual mapping 501. In some instances, a sequence of menu options 505 may be selected by the user before the user receives a desired service or function of IVR 310. The user may have to provide a series or sequence of menu inputs 503a-503k (referred to herein generally as menu inputs 503) into the communication device in order for the IVR 310 to route the communication device 301 to the desired service or function. Menu inputs 503 may be transmitted to IVR 310 using a keypad, keyboard or other input device whereby the menu inputs 503 are mapped to corresponding DTMF tones. For example, if a user would like to talk to a sales agent regarding a new order as depicted by menu option 503d, a user would have to input menu option 503a and 503f in the sequential order as they appear in the visual mapping 501, starting from main menu 504. In this case, the sequence corresponds to an input sequence of “1, 1” entered via a keypad or other input device of the communication device 301; transmitting DTMF tones for the digit “1” two times, signaling to IVR 310 to connect communication device 301 to an agent communication device 317. Alternatively, if the user viewing the visual mapping 501 wants to lookup tracking information as depicted by menu option 505f, then from the main menu 504 of IVR 310, a user may input into the keypad of communication device 301 an input sequence corresponding to menu inputs 503a, 503g, 503j which are transmitted as DTMF tones using the digits “1, 3, 2” on the keypad. In response to decoding the DTMF tones for the sequence of digits “1, 3, 2”, IVR 310 may play a recorded sales info voice message 505g, which may include the tracking information requested by the user.

In some embodiments, web server 307 or other type computing system hosting the file containing the visual mapping of the IVR menu options may indicate Time-to-Live (TTL) or other times of content-coherence values, that may allow the communication device 301 to display and reuse and previously fetched version of the visual mapping of the IVR menu options during subsequent calls to the IVR 310 for a specified period of time. TTL may refer to a value in computer networking that specifies how long a piece of data should be considered valid or usable (in this case the file containing the visual mapping of IVR menu options). In the context of content coherence, the TTL value determines how long a piece of content should be considered fresh or current before it is updated or refreshed. The TTL value is usually expressed as a number of seconds and may be set by the content provider or system administrator. Once the TTL has expired, the file may be considered outdated and may need to be refreshed or updated from the source. The purpose of using TTL values for content coherence is to ensure that users are accessing up-to-date information, and to reduce the amount of traffic on the network 102 by limiting the frequency of content updates. By setting a TTL value, the content provider can control the rate at which the content is updated and ensure that users are accessing the most current information. In the case of the visual mapping of IVR menu options, the use of a TTL value may ensure that previously retrieved mappings still correspond to the current menu presented by IVR 310 and if the visual mapping is outdated, an updated visual mapping may need to be retrieved by communication device 301.

In some embodiments, communication device 301 may visually track menu inputs 503 being transmitted by the user and may update the visual mapping 501 to indicate the user's pathway through the menu options 505 of the IVR menu. The updates to the visual mapping 501 may be displayed in real-time as the user selects menu options 505 by inputting numbers or symbols from the keypad or keyboard of the communication device 301. FIG. 5C provides a visual example of a visual mapping 501 being displayed by display 305, wherein the visual mapping 501 is updated with a visualized pathway 515a-515c depicting a user's current position within the IVR menu (as denoted by position 515c) and previous positions along the pathway within the IVR menu as denoted by positions 515a, 515b. As the user continues to make menu option selections, the visual mapping may continue to update by adding additional visual elements that highlight the user's position along the pathway. By being able to visually track the user's selected menu options 505 the user may be better able to understand both their current position amongst the entirety of the IVR menu and doing so may assist the user to identify an end goal of the pathway more clearly; specifically, a service or function of IVR 310 that the user is trying to reach within the IVR menu.

Embodiments of communication device 301 may integrate the use of historical learning, artificial intelligence, and/or predictive modeling, in combination with the visual mapping of IVR menu options to output predictive pathways 510 of menu options 505 that may be most useful to a user accessing IVR 310. FIG. 5B depicts an example of a visual mapping 501 comprising a predictive pathway 510 being displayed to a user via display 305. Communication device 301 may predict, based on historical data collected and stored about the user, including user preferences, behaviors, past interactions with IVR 310, and other data trends by the user, including keywords, contextual indicators providing clues regarding the types of services or functions the user is intending to access while connected to IVR 310. In the example provided in FIG. 5B, the communication device is predicting the user is most likely connecting to IVR 310 to lookup tracking information about an existing order as shown by the highlighted predictive pathway 510. A user accessing the visual mapping 501 may be greeted with the visual mapping 501 displaying the predictive pathway in some embodiments. In other embodiments a user may interact with a chatbot or other interface 512 which, through a series of chat prompts back and forth presents the predicted pathway 510. As shown in FIG. 5B, the chatbot or interface 512 may visually instruct the user how to reach the services or functions predicted to be needed by the user. In this example, the interface 512 instructs the user “from the main menu dial 1, 3, 2 to lookup information for an existing order.” If the user is intending to lookup an existing order as predicted, the user can choose to follow the instructions provided by the chatbot or interface 512 using the keypad or keyboard of the communication device to transmit corresponding DTMF tones to IVR 310.

In some embodiments of communication device 301, predicted pathways 510 through the IVR menu can be made or customized for the user based on the location of the user. Hardware or software components of communication device 301 may report the location of the user, and locational awareness may be used as a factor when predicting pathways through the IVR menu. Location of the user can be used as a determining factor pertaining to “how” or “why” a user may be utilizing IVR 310 and therefore can be used to predict which functions or features a user may be interested in being routed toward. A locational awareness factor may be weighted into the decision making of predicted pathways 510 by the communication device 301. If the user has a locational awareness factor that carries priority, then the communication device 301 and software thereof making pathway predictions can react accordingly and leverage the known location of the user for a specific tailored routing experience and path.

In some embodiments, contextual awareness or content awareness may be implemented by communication device 301 and/or IVR 310 to predict which services or functions of IVR 310 that a user may be trying to access. Communication device 301 or IVR 310 may use contextual and context awareness to correct for perceived user error that may occur when a user is selecting one or more menu options from the IVR menu. For instance, IVR 310 may be able to ameliorate the handling or routing path of the menu option selections based on context. If the context is known, IVR 310 may be able to supersede mistakes made by the user while inputting menu option selections, resulting in IVR 310 correcting the mistakes or mis-steps during processing of the user inputs at IVR 310 by menu module 311. Likewise, communication device 301 may be able to take into account contextual awareness and correct for user errors by adjusting the DTMF tones being transmitted by the communication device 301. Instead of transmitting DTMF tones corresponding to the user's actual (mistaken) input, communication device 301 can correct the input, changing the input to the number or symbol of the keypad or keyboard mapped to the menu option predicted to be correct based on the context, instead of the erroneous selection made by the user.

Referring back to the drawing of FIG. 3B, FIG. 3B depicts an alternative embodiment of a computing environment 350, which may be used to implement sequence 450 illustrated in FIG. 4B. As shown in FIG. 3B, the system may include a gateway that enables text-based messaging or notifications to be transmitted and received between IVR 310 and communication device 301. In the example computing environment 350, an SMS gateway 323 may be incorporated into the system and enable SMS text message delivery and receipt between IVR 310 and a telephone number provided by communication device 301. Instead of relying solely on decoding auditory signals (such as DTMF) to be exchanged by IVR 310 and communication device 301, embodiments of IVR 310 can transmit locations of files containing visual mappings of the IVR menu options using messaging protocols such as SMS protocols to directly generate and transmit text-based location information to an address provided by communication device 301. For example, transmitting SMS messages to a phone number associated with communication device 301.

Using text-based messages, IVR 310 can provide representations of location information of the visual mapping of the IVR menu options to communication device 301 in a text format. Likewise, communication device 301 may use the text-based message information to connect to locations hosting the file. For example, by connecting to a web server 307 or other types of remote servers 104 hosting the visual mapping of the IVR menu options at the provided location. Moreover, communication devices 301 may download the file locally to communication device 301. The use of text-based messaging to communication file location information may allow for communication device 301 to locate the mapping of the IVR menu options without having to decode a long set of audio signals provided by IVR 310 into an ASCII character set, or other text format in order to visualize the file location information. Once the file is downloaded or opened remotely via the network 102, a user of the communication device 301 can simultaneously view IVR menu option pathways visually, while also listening to the pre-recorded messages provided by the IVR 310 as discussed in detail above. Communication devices 301 can input menu option selections based on a combination of the visualized mapping and/or the auditory instructions provided by IVR 310 to have the IVR 310 execute functions and provide selected content or functions to the user of the communication device 301.

Referring to the drawing of FIG. 4B, sequence 450 begins with steps 402-405 similar to sequence 400 as described above, wherein a user 401 dials a phone number, communication device 301 places a call to IVR 310 and IVR 310 answers the incoming call. In response to the incoming call placed during step 403, IVR 310 may respond in step 430 by transmitting an ASCII encoded message as DTMF tones indicating a length of a URL or other location information for the file containing the visual mapping of the IVR menu options. In response to receiving the URL transmitted during step 430 and decoding the message via DTMF decoder 303, during step 431 communication device 301 may transmit ASCII encoded message back to IVR 310. The message may provide a phone number or other type of address where the communication device 301 can receive data or connections. The encoded message may be transmitted back to IVR 310 using DTMF tones, wherein upon receipt and decoding of the phone number, IVR 310 may in step 408 halt message playback and enter a standby mode.

During step 433 of sequence 450, IVR 310 creates a text message using SMS protocol or another type of text messaging service. The message contains a representation of a URL or other location indicator in a textual format. IVR 310 transmits the message containing the URL via SMS protocol to the phone number or address provided during step 431, via SMS gateway 323. Upon receiving the message from IVR 310 SMS gateway 323, in step 435, relays the SMS message to the phone number provided by communication device 301. Upon receipt of the SMS message by the communication device 301, sequence 450 may proceed in the same manner as sequence 400, whereby steps 413-425 are performed as described above.

### Method for Visualizing Menu Options of an Ivr System

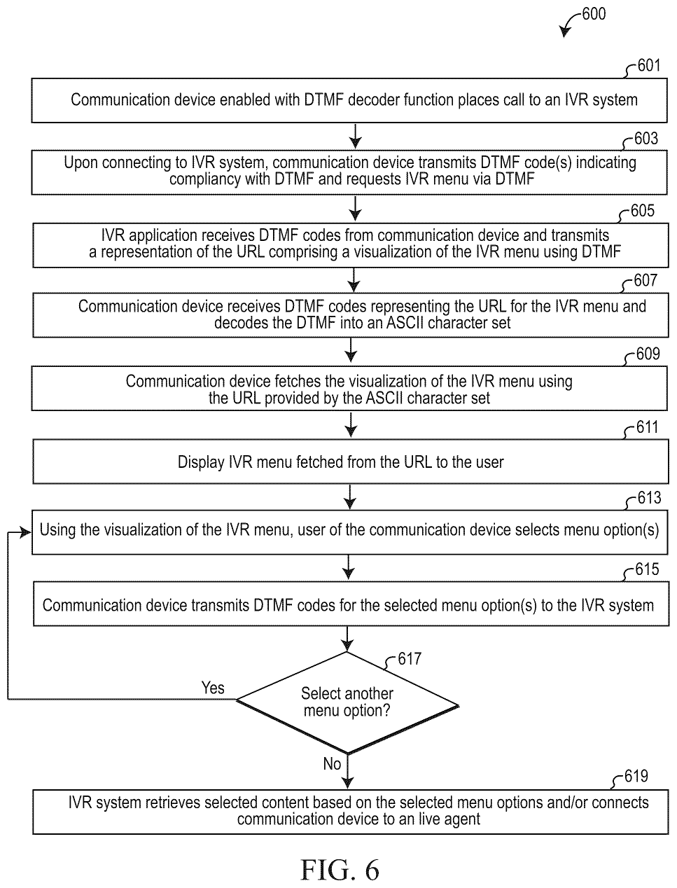

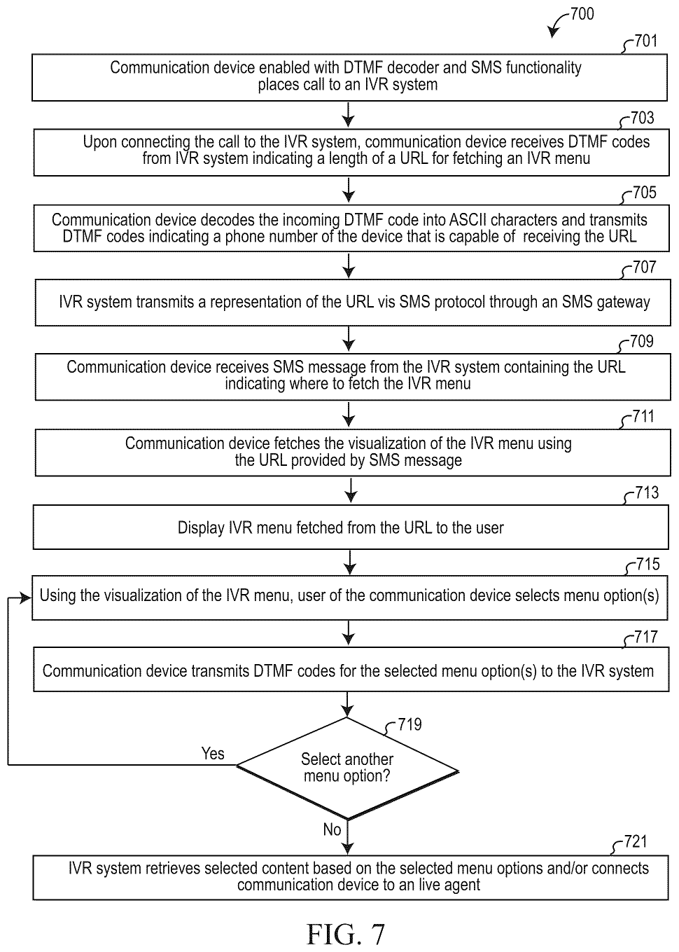

The drawings of FIGS. 6-7 represent an embodiment of method 600 and an alternate embodiment of a method 700 for visualizing menu options of an IVR 310. The embodiments of methods 600, 700 can be implemented in accordance with the computing systems and examples depicted in FIGS. 1-5C above and as described throughout this application. A person skilled in the art should recognize that the steps of the methods 600, 700 described in regard to FIGS. 6-7 may be performed in a different order than presented and may not require all the steps described herein to be performed.

The embodiment of method 600, as shown and described in FIG. 6, may begin at step 601. During step 601, a communication device 301 enabled with a DTMF decoder 303, internet or other network capabilities and/or functionality that permits visual displays of information onto the communication device 301 may place a phone call to establish a connection with an IVR 310. Upon connecting the communication device 301 to IVR 310, the communication device 301 may, in step 603, transmit one or more DTMF codes to IVR 310. The DTMF codes may be audible tones that may encode a message or greeting that indicates to IVR 310 that the connected communication device 301 exhibits compliancy with standard for decoding DTMF, visualization capabilities and/or internet or network accessibility functions. For example, the communication device 301 may transmit a greeting such as “H-E-L-O” in DTMF tones to IVR 310 as the indication that communication device 301 complies with one or more appropriate standards for receiving location information of files that include visual mappings of the IVR menu options. The greeting “H-E-L-O” in DTMF tones may be mapped to hexadecimal codes “48, 45, 4c, 4f”.

In step 605, the receipt of the greeting message as DTMF tones by IVR 310 may cause IVR 310 to stop message playback and enter into a standby mode for sending and/or receiving data over the established connection with the communication device 301. In the exemplary embodiment, IVR 310 may transmit a representation of a URL providing a location of a file or document containing a visual mapping of the IVR menu options, to the communication device 301. The transmission of the URL may be in the form of DTMF codes that are encoding an ASCII character set that once decoded will reveal the URL in a text format. Upon completion of the transmission of DTMF codes encoding the message comprising the URL, IVR 310 may transmit a set of codes indicating completion of the transmission. For instance, an IVR 310 may transmit “D-O-N-E” (i.e., “44, 4f, 4e, 45” in DTMF) or other similar phrases to indicate to the communication device 301 that transmission of the data stream of DTMF codes comprising the URL has completed. In some embodiments, IVR 310 may utilize the TORRID protocol as a method for compressing the encoded ASCII character set message as a 7-bit sequence instead of the 8-bit DTMF sequence.

In some embodiments, upon completion of the data stream of DTMF codes comprising the URL is completed and a set of DTMF codes have been transmitted to the communication device 301 indicating transmission of the URL is complete, a verification request for a hash of the file containing the visual mapping of the IVR menu can be transmitted in DTMF codes to IVR 310. For example, communication device 301 can transmit the phrase “VRFY” using DTMF tones to make the request. In response to the verification request, IVR 310 may further transmit the 128 bit MD5 hash of the file comprising the visual mapping of the IVR menu options to the communication device 301. The 128 bit MD5 hash may be transmitted using 16 DTMF tones (i.e., 128 bits/8 bit=16). Upon completion of the DTMF tones for the file's hash, a termination word does not need to be included. Communication device 301 may automatically recognize the completion of the hash upon receipt of the 16th DTMF tone because MD5 hashes are a known size.

In Step 607, communication device 301 receives the DTMF codes representing the URL describing the file location for the visual mapping of the IVR menu options, and the DTMF codes for the hash of the file (if requested). The DTMF decoder 303 of the communication device 301 may decode the DTMF tones received from IVR 310 into an ASCII character set, revealing the URL to access the file containing the visual mapping of the IVR menu options. With the URL decoded into a text format, the communication device 301 may, in step 609, fetch the visual mapping of the IVR menu options from the host location prescribed by the URL. For example, communication device 301 may copy the text of the decoded URL into a web browser and connect to a host computer such as a web server 307 or other remote servers 104 storing the requested file. In step 611, the communication device 301 may open and/or display the visual mapping of the IVR menu options fetched from the URL. In some embodiments, communication device 301 may download the file containing the visual mapping of the IVR options locally to a storage device of the communication device 301 and open the file locally for display. In other embodiments, communication device 301 may open the file remotely for viewing over the network 102. For example, by displaying the visual mapping of the IVR menu options within a web browser window or other type of thin client being used to access web server 307 or other type of remote server 104.

In step 613, the user can simultaneously view the visual mapping of the IVR menu options on the display 305 of the communication device 301, listen to menu options or instructions audibly being transmitted to the communication device 301 by IVR 310 and input DTMF codes corresponding the menu options of the IVR menu (depending on the current layer of the IVR menu that the communication device 301 is currently within while connected to IVR 310) using a keypad of the communication device and/or audible verbal communications translated into DTMF using natural language processing (NLP) to recognize the verbal inputs of the user. In step 615, communication device 301 transmits one or more DTMF codes for selected menu options to IVR 310. In step 617, upon inputting a first DTMF code or a set of DTMF codes, a determination can be made whether a user is selecting another menu option within the IVR menu as indicated by additional DTMF codes being transmitted to IVR 310. If additional DTMF codes are being transmitted, the method 600 may return to step 613 whereby the communication device continues to select IVR menu options by inputting additional DTMF codes to IVR 310. Otherwise, if additional DTMF codes are not being transmitted, indicating additional menu options are not being selected, the method 600 may proceed to step 619, wherein IVR 310 retrieves the selected content based upon the IVR menu options inputted by the communication device 301 as DTMF codes, and/or connects the communication device to a live agent. For example, based on the inputted DTMF codes, a communication device may be accessing a pre-recorded message or other information stored by a data repository 319, a voicemail service 321 allowing the user to leave a voice message and/or the communication device 301 may be connected to an agent communication device 317, enabling a voice and/or video channel to be opened for facilitating live communication with an agent or representative.

The alternative embodiment of visualizing IVR menu options of an IVR system are shown and described by method 700 of FIG. 7. Method 700 may begin at step 701. During step 701, a communication device 301 that is enabled with a DTMF decoder 303, and SMS functionality places a phone call with IVR 310. In step 703, upon the communication device 301 connecting the call to IVR 310, communication device receives one or more DTMF tones from IVR 310. The incoming DTMF tones being received encode a message indicating the length of characters that makeup a URL indicating a location of the file containing the visual mapping of the IVR menu options. During step 705, the DTMF decoder 303 decodes the incoming DTMF tones provided by IVR 310 into ASCII characters. In response to receiving the length of the URL as part of the encoded message from IVR 310, communication device 301 may transmit a plurality of DTMF codes to IVR 310 encoding a message indicating an address such as a phone number, which communication device 301 is capable of receiving the URL for the file containing the visual mapping of the IVR menu options.

In step 707, IVR 310 generates a text message using SMS protocol and transmits the SMS text message via an SMS gateway 323 to the phone number or other type of address provided by communication device 301 in step 705. The SMS text message comprises at least the URL indicating the location of the file containing the visual mapping of the IVR menu options. During step 709, the communication device 301 receives the SMS text message comprising the URL from IVR 310. In step 711, the communication device 301 fetches the visual mapping of the IVR menu options using the URL. The SMS message may provide a direct hyperlink to the file location in some embodiments, while in other embodiments, the communication device 301 may copy and paste the URL into a web browser or other type of thin client to access the file stored at the location provided by the URL. In step 713, communication device may display the visual mapping of the IVR menu options. Similar to method 600, in method 700, in order to display the contents of the file, communication device 301 may download the file containing the visual mapping of the IVR menu options locally to a storage device of the communication device 301 and open the file locally for display. In other embodiments, communication device 301 may open the file remotely for viewing over the network 102. For example, by displaying the visual mapping of the IVR menu options within a web browser window or other type of thin client being used to access web server 307 or other type of remote server 104.

In step 715, with the display of the visualized IVR menu options, the user can simultaneously view the visual mapping of the IVR menu options on the display 305 of the communication device 301 and listen to menu options or instructions audibly being transmitted to the communication device 301 by IVR 310. Using a keypad of the communication device 301 and/or by providing audible verbal communications translated into DTMF using natural language processing (NLP) to recognize the verbal inputs of the user input DTMF codes corresponding the menu options of the IVR menu (depending on the current layer of the IVR menu that the communication device 301 is currently within while connected to IVR 310), the user can input menu selections and transmit the selections to the IVR 310. In step 717, communication device 301 transmits one or more DTMF codes for selected menu options to IVR 310. In step 719, upon inputting a first DTMF code or a set of DTMF codes, a determination can be made whether a user is selecting another menu option within the IVR menu as indicated by additional DTMF codes being transmitted to IVR 310. If additional DTMF codes are being transmitted, the method 700 may return to step 715, whereby the communication device 301 continues to select IVR menu options by inputting additional DTMF codes to IVR 310. Otherwise, if additional DTMF codes are not being transmitted, indicating additional menu options are not being selected, the method 700 may proceed to step 721, wherein IVR 310 retrieves the selected content based upon the IVR menu options inputted by the communication device 301 as DTMF codes, and/or connects the communication device to a live agent. For example, based on the inputted DTMF codes, a communication device may be accessing a pre-recorded message or other information stored by a data repository 319, a voicemail service 321 allowing the user to leave a voice message and/or the communication device 301 may be connected to an agent communication device 317, enabling a voice and/or video channel to be opened for facilitating live communication with an agent or representative.

What is claimed is:

1. A computer-implemented method for visualizing menu options of an interactive voice response (IVR) system, the computer-implemented method comprising:
establishing, by one or more processors, a connection with the IVR system;
transmitting, by the one or more processors, a first message comprising a signal to the IVR system indicating compliance with decoding signals of the IVR systems and compliance with displaying the visualization of menu options thereby requesting the visualization of menu options for the IVR system;
receiving, by the one or more processors, a second message from the IVR system, the second messaged encoded with information describing a location of a file containing the visualization of the menu options for the IVR system;
decoding, by the one or more processors, the second message, revealing the location of the file;
retrieving, by the one or more processors, the file containing the visualization of the menu options for the IVR system from the location; and
displaying, by the one or more processors, the visualization of the menu options for the IVR system.

2. The computer-implemented method of claim 1, wherein the first message and the second message comprise dual-tone multi-frequency (DTMF) codes.

3. The computer-implemented method of claim 2, wherein the DTMF codes of the second message encode an ASCII character set.

4. The computer-implemented method of claim 3, wherein upon decoding the second message into the ASCII character set from the DTMF codes, the ASCII character set represents a universal resource locator (URL) providing the location of the file containing the visualization of the menu options for the IVR system.

5. The computer-implemented method of claim 2, wherein the DTMF codes of the second message implement a Transport of Reduced References In DTMF (TORRID) compression protocol specification.

6. The computer-implemented method of claim 4, wherein the retrieving step includes retrieving the file containing the visualization of the menu options for the IVR system from a web server hosting the file at the location provided by the URL decoded from the second message; and
upon displaying the visualization of the menu options for the IVR system, transmitting to the IVR system, one or more DTMF codes corresponding to the menu options being displayed by the file.

7. The computer-implemented method of claim 6, further comprising:
upon transmitting each of the one or more DTMF codes corresponding to the menu options, updating, by the processor, the visualization of the menu options to visually indicate each of the menu options being selected by the one or more DTMF codes, tracking a position within an IVR menu of the IVR system.

8. A computer system for visualizing menu options of an interactive voice response (IVR) system, the computer system comprising:
a processor; and
a computer-readable storage media coupled to the processor, wherein the computer-readable storage media contains program instructions executing, via the processor, a computer-implemented method comprising:
establishing, the processor, a connection with the IVR system;
transmitting, by the processor, a first message comprising a signal to the IVR system indicating compliance with decoding signals of the IVR systems and compliance with displaying the visualization of menu options thereby requesting the visualization of menu options for the IVR system;
receiving, by the processor, a second message from the IVR system, the second messaged encoded with information describing a location of a file containing the visualization of the menu options for the IVR system;
decoding, by the processor, the second message, revealing the location of the file;
retrieving, by the processor, the file containing the visualization of the menu options for the IVR system from the location; and
displaying, by the processor, the visualization of the menu options for the IVR system.

9. The computer system of claim 8, wherein the first message and the second message comprise dual-tone multi-frequency (DTMF) codes.

10. The computer system of claim 9, wherein the DTMF codes of the second message encode an ASCII character set and upon decoding the second message into the ASCII character set from the DTMF codes, the ASCII character set represents a universal resource locator (URL) providing the location of the file containing the visualization of the menu options for the IVR system.

11. The computer system of claim 9, wherein the DTMF codes of the second message implement a Transport of Reduced References In DTMF (TORRID) compression protocol specification.

12. The computer system of claim 10, wherein the retrieving step includes retrieving the file containing the visualization of the menu options for the IVR system from a web server hosting the file at the location provided by the URL decoded from the second message; and
upon displaying the visualization of the menu options for the IVR system, transmitting to the IVR system, one or more DTMF codes corresponding to the menu options being displayed by the file.

13. The computer system of claim 12, further comprising:
upon transmitting each of the one or more DTMF codes corresponding to the menu options, updating, by the processor, the visualization of the menu options to visually indicate each of the menu options being selected by the one or more DTMF codes, tracking a position within an IVR menu of the IVR system.

14. A computer-implemented method for visualizing menu options of an interactive voice response (IVR) system, the computer-implemented method comprising:
establishing, by one or more processors, a connection with the IVR system;
receiving, by the one or more processors, a first message from the IVR system encoded with information describing a length of a third message describing a location of a file containing a visualization of menu options for the IVR system;
transmitting, by the one or more processors, a second message to the IVR system, where the second message is encoded with information containing an address to send the third message;
receiving, by the one or more processors, the third message at the address encoded within the second message, said third message comprising the location of the file;
based on the location of the file provided within the third message, retrieving, by the processors, the file containing the visualization of the menu options for the IVR system from the location; and
displaying, by the one or more processors, the visualization of the menu options for the IVR system.

15. The computer-implemented method of claim 14, wherein the first message encodes the information describing the length of the third message and the second message encodes the information containing the address, using dual-tone multi-frequency (DTMF) codes.

16. The computer-implemented method of claim 15, wherein the address encoded within the second message is a phone number.

17. The computer-implemented method of claim 15, wherein the DTMF codes implement a Transport of Reduced References In DTMF (TORRID) compression protocol specification.

18. The computer-implemented method of claim 16, wherein third message is a Short-Message-System (SMS) text message sent to the phone number.

19. The computer-implemented method of claim 18, wherein the SMS text message comprises a universal resource locator (URL) for accessing the location of the file.

20. The computer-implemented method of claim 19 wherein the retrieving step includes retrieving the file containing the visualization of the menu options for the IVR system from a web server hosting the file at the location provided by the URL; and
upon displaying the visualization of the menu options for the IVR system, transmitting to the IVR system, one or more DTMF codes corresponding to the menu options being displayed by the file.
